(19) United States
(12) Patent Application Publication
(10) Pub. No.: US 2007/0002258 A1
(43) Pub. Date: Jan. 4, 2007

(54) LIQUID CRYSTAL DISPLAY PANEL AND METHOD FOR REPAIRING THE SAME

(76) Inventor: Mei-Yeh Wu, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,400

(22) Filed: Aug. 2, 2005

(30) Foreign Application Priority Data
Jun. 30, 2005 (TW) 94122082

(51) Int. Cl. G02F 1/1339

(52) U.S. Cl. 349/155

(57) ABSTRACT

A liquid crystal display panel and method for repairing the same are provided. The liquid crystal display panel comprises a first substrate, a second substrate, a liquid crystal layer, a patterned spacer and a sealant. The first substrate has a non-display area. The second substrate is disposed on the first substrate. The liquid crystal layer is disposed between the first substrate and the second substrate. The patterned spacer surrounds the liquid crystal layer and wherein the patterned spacer has a plurality of liquid crystal containing spaces. The sealant is disposed between the non-display area of the first substrate and the second substrate, as well as encloses the patterned spacer. When gravity mura happens to the liquid crystal display panel, the patterned spacer are removed away to allow the excess liquid crystal to flow into the liquid crystal containing spaces.

### CROSS-REFERENCE TO RELATED APPLICATION

This application claims the priority benefit of Taiwan application serial no. 94122082, filed Jun. 30, 2005. All disclosure of the Taiwan application is incorporated herein by reference.

### BACKGROUND OF THE INVENTION

1. Field of the Invention

The present invention generally relates to a liquid crystal display (LCD) panel, and more particularly, to a liquid crystal display panel and method for repairing the same.

2. Description of Related Art

With optoelectronic and semiconductor technologies advance, technologies for fabricating a planar display are matured. Among the planar displays, a liquid crystal display with advantages of high image quality, high compactness, low power consumption and free radiation has become a main stream of the market. In addition, the liquid crystal display comprises a liquid crystal display panel and a backlight module, wherein the backlight module provides the liquid crystal display panel with a required light source.

The liquid crystal display panel, for example, consists of a colour filter substrate, an active matrix substrate and a liquid crystal layer sandwiched between these two substrates. It is noticeable that a gap between the colour filter substrate and the active matrix substrate must be kept uniform so as to make the liquid crystal display panel have a better display quality. In general, to make the gap between these two substrates be kept a constant value, ball-type spacer or photospacer are usually disposed between these two substrates. Nowadays, one drop fill (ODF) process has been developed to fill the liquid crystal into the gap between these two substrates.

In addition, the one drop fill (ODF) processes comprise first coating a heat curing glue or ultraviolet curing glue onto one of the active matrix substrate and the colour filter substrate to form an enclosed area. Then, the liquid crystal is drop-filled into the enclosed area, followed by adhering the active matrix substrate to the colour filter substrate by using a method of heating or ultraviolet light radiation.

However, when the liquid crystal drop-filled process is improperly controlled, an amount of the liquid crystal filled into the gap between these two substrates may be excess or insufficient. Furthermore, when the amount of the liquid crystal is insufficient, bubbles happens to the liquid crystal layer. In the other hand, when the amount of the liquid crystal is excess, liquid crystal gravity mura occurs because the excess liquid crystal is affected by gravity due to the panel's vertical arrangement when used. In addition, when proceeding with a burn-in test, the liquid crystal's inflation affects the display quality of the liquid crystal display panel.

### SUMMARY OF THE INVENTION

Accordingly, the present invention is directed to a liquid crystal display panel with a better display quality.

In addition, the present invention is further directed to a method for repairing the liquid crystal display panel to alleviate a liquid crystal non-uniformly distributed phenomenon.

Based on the above mentioned objective or other objectives, the present invention provides a liquid crystal display panel, which comprises a first substrate, a second substrate, a liquid crystal layer, a patterned spacer and a sealant. Moreover, the first substrate has a non-display area and the second substrate is disposed on the first substrate. The liquid crystal layer is disposed between the first substrate and the second substrate. In addition, the patterned spacer is disposed between the non-display area of the first substrate and the second substrate, as well as encloses the liquid crystal layer. In addition, the patterned spacer has a plurality of liquid crystal containing spaces. Furthermore, the sealant is disposed between the non-display area of the first substrate and the second substrate, as well as encloses the patterned spacer.

According to one embodiment of the present invention, the patterned spacer may comprises a first spacer, a second spacer and a plurality of third spacers. In addition, the first spacer encloses the liquid crystal layer while the second spacer encloses the first spacer. More, the second spacer is spaced from the first spacer by a gap, and the plurality of third spacers are disposed between the first spacer and the second spacer. In addition, the gap is further partitioned and the first spacer, the second spacer, the third spacer, the first substrate and the second substrate, define the liquid crystal containing spaces.

According to one embodiment of the present invention, the first spacer and the second spacer may be a rectangular shape.

According to one embodiment of the present invention, material of the patterned spacer may comprise photo-resist material.

According to one embodiment of the present invention, the liquid crystal display panel may further comprise a black matrix layer, disposed between the non-display area of the first substrate and the second substrate, as well as between the patterned spacer and the first spacer.

Based on one embodiment of the present invention, the first substrate may be an active device array substrate.

Based on one embodiment of the present invention, the first substrate may be a color filter substrate.

Based on one embodiment of the present invention, material of the sealant may be heat-solidified glue.

Based on one embodiment of the present invention, material of the sealant may be ultraviolet-solidified glue.

Based on the above mentioned objective or other objectives, the present invention provides a method for repairing the liquid crystal display panel, suitable for proceeding with repairing the aforementioned liquid crystal display panel. More, when the liquid crystal non-uniformly distributed phenomenon happens to the liquid crystal display panel, the repairing method is to remove partial patterned spacer to allow the excess liquid crystal to flow into the liquid crystal containing spaces.

According to one embodiment of the present invention, a method for removing partial patterned spacer implements a laser with wavelengths of ultraviolet light.

Based on the foregoing description, the patterned spacer with the liquid crystal containing spaces is arranged in the non-display area of the liquid crystal display panel of the present invention. Therefore, the patterned spacer can be partially removed to allow the excess amount of the liquid crystal to flow into the liquid crystal containing spaces when the amount of the liquid crystal is excess. As a result, the liquid crystal is more uniformly distributed and thus promotes display quality of the liquid crystal display panel.

The objectives, other features and advantages of the invention will become more apparent and easily understood from the following detailed description of the invention when taken in conjunction with the accompanying drawings.

### BRIEF DESCRIPTION OF THE DRAWINGS

FIG. 1 shows a top view of a liquid crystal display panel of one embodiment of the present invention.

FIG. 2 is partial cross sectional view along the A-A′ line shown in FIG. 1.

FIG. 3 is partial cross sectional view along the B-B′ line shown in FIG. 1.

### DESCRIPTION OF THE EMBODIMENTS

Reference will now be made in detail to a decoding device for product code decoding and decoding method thereof, examples of which are illustrated in the accompanying drawings. Wherever possible, the same reference numbers are used in the drawings and the descriptions to refer to the same parts.

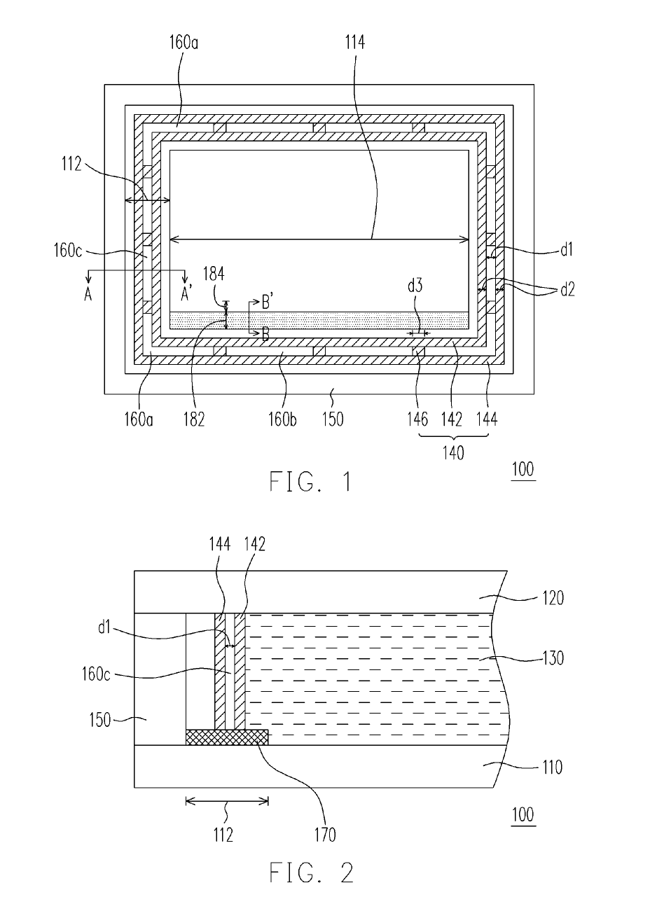

FIG. 1 shows a top view of a liquid crystal display panel of one embodiment of the present invention and FIG. 2 is a partial cross sectional view along the A-A′ line shown in FIG. 1. Referring to FIGS. 1 and 2 concurrently, a liquid crystal display panel 100 comprises a first substrate 110, a second substrate 120, a liquid crystal layer 130, a patterned spacer 140 and a seal frame 150. In addition, the first substrate 110, for example, comprises a display area 114 and a non-display area 112 enclosing the display area 114. In one embodiment, the first substrate 110 may be, for example, an active device array substrate, which may be a thin film transistor (TFT) array substrate or a diode array substrate.

Moreover, the second substrate 120 is disposed on the first substrate 110, and may be, for example, a color filter substrate on which a plurality of red, green and blue filter films (not shown) are disposed. Besides, these filter films respectively corresponds pixels on the first substrate 110 so as to enable the liquid crystal display panel 100 to display a full color image. In another embodiment, the first substrate 110 may be a color filter substrate while the second substrate 120 may be an active device array substrate.

Furthermore, the liquid crystal layer 130 is disposed between the first substrate 110 and the second substrate 120. It is noticeable that the patterned spacer 140 is disposed between the non-display area 112 of the first substrate 110 and the second substrate 120, encloses the liquid crystal layer 130 as well as has a plurality of the liquid crystal containing spaces 160a, 160b and 160c.

The seal frame 150 is disposed between the non-display area 112 of the first substrate 110 and the second substrate 120, and encloses the patterned spacer 140. The seal frame 150 functions to adhere these two substrates 110,120, and to seal the liquid crystal between these two substrates 110 and 120. In addition, in one embodiment, material of the sealant 150 may be, for example, heat-solidified glue or ultraviolet-solidified glue, which can be solidified by using a heating or an ultraviolet radiation, to secure two substrates 110 and 120 together.

In addition, the liquid crystal display panel 100 may further comprises a black matrix layer 170 disposed thereon, which is further disposed between the non-display area 112 of the first substrate 110 and the second substrate 120, and between the patterned spacer 140 and the first substrate 110. In addition, the black matrix layer 170 encloses the display area 114 so as to alleviate a light leaking problem and promote contrast of the liquid crystal display panel 100.

In one embodiment, the first substrate 110 is a substrate on which a color filter film is made on a color filter array (COA), and the second substrate 120 is a glass substrate. Meanwhile the black matrix layer 170 may be fabricated the COA structure. In another embodiment, the first substrate 110 is an active array substrate and the second substrate 120 is a color filter substrate. Meanwhile, the black matrix layer 170 may be fabricated on the color filter substrate.

Referring to FIGS. 1 and 2 concurrently, the patterned spacer 140 may, for example, comprise a first spacer 142, a second spacer 144 and a plurality of third spacers 146. In addition, the first spacer 142 encloses the liquid crystal layer 130 while the second spacer 144 encloses the first spacer 142. There is a gap d1 between the second spacer 144 and the first spacer 142, and this gap d1 may be, for example, 5 μm. In addition, these third spacers 146 are disposed between the first spacer 142 and the second spacer 144, and partition a space of the gap d1. In addition, the first spacer 142, the second spacer 144, the third spacer 146, the first substrate 110 and the second substrate 120 define the liquid crystal containing spaces 160a, 160b and 160c.

Top views of the first spacer 142 and the second spacer 144 may be, for example, a rectangular shape. Moreover, as shown in FIG. 1, the first spacer 142 and the second spacer 144 have a width d2, which may be 2 μm. Each third spacer 146 has a length d3 and a width d1 (i.e. the gap d1), wherein the length d3 may be, for example, 2 μm and the width d1 may be, for example, 5 μm. It is noticeable that volumes of the plurality of the liquid crystal containing spaces 160a, 160b and 160c can be changed by changing the gap d1, the width d2 of the spacers and the length d3 of the third spacer 146. In addition, top views of the first spacer 142 and the second spacer 144 may be not limited to the rectangular shape shown in FIG. 1 but a circular, ellipse or polygon shape.

Material of the patterned spacer 140 may be photo-resist material so that the patterned spacer 140 can be fabricated by a conventional photolithography process. In addition, since the patterned spacer 140 is not located in the display area 114, the display quality can not be affected. It is noticeable that when the liquid crystal non-uniformly distributed phenomenon happens to the liquid crystal display panel, the liquid crystal display panel 100 can proceed with being repaired. The following describes a method for repairing the aforementioned liquid crystal display panel 100.

when the liquid crystal non-uniformly distributed phenomenon happens to the liquid crystal display panel, this repairing method may, for example, partially removing a portion of the patterned spacer 140 to allow the excess amount of the liquid crystal to flow into a portion of liquid crystal containing spaces 160a, 160b and 160c. In addition, a method for partially removing the patterned spacer 140 may, for example, use a laser with wavelengths of, for example, an ultraviolet light and having an energy of, for example, 0.1 mJ.

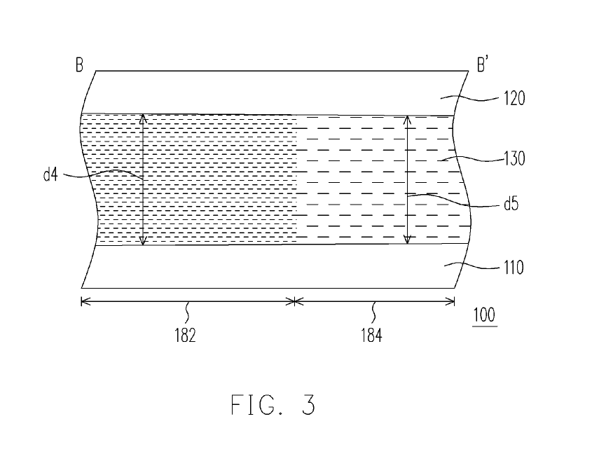

FIG. 3 shows a partial cross sectional view along the B-B′ line shown in FIG. 1. Referring to FIG. 3, the detail repairing steps are described as follows. First of all, a widths d5 of the liquid crystal uniformly distributed area 184 and a widths d4 of the liquid crystal non-uniformly distributed area 182 are measured, wherein the widths d5 and d4 are two substrates 110 and 120, respectively.

Next, an area of the liquid crystal non-uniformly distributed area 182 is measured. The excess volume of the liquid crystal is then calculated and this excess volume is equal to (the area of the liquid crystal non-uniformly distributed area 182)×(the width d4 of the liquid crystal non-uniformly distributed area 182− the widths d5 of the liquid crystal uniformly distributed area 184). In addition, it is the excess volume of the liquid crystal that determines how many patterned spacers 140 to be removed in order to release enough liquid crystal containing spaces 160a, 160b and 160c.

Referring back to FIG. 1, in general, the liquid crystal display panel 100 is vertically arranged when used so that the liquid crystal is affected by gravity and accordingly accumulates on the bottom of the panel 100. Therefore, the first spacer 142 at the right-bottom corner or at the left-bottom corner is first removed to allow the liquid crystal containing space 160a to receive the excess volume of the liquid crystal. After that, it is evaluated to determine whether to proceed with removing the spacer 142 disposed over the top of the panel 100 or underneath the bottom of the panel 100 to open the liquid crystal containing space 160b. If the amount of liquid crystal is still excess, the first spacer 142 is proceeded to be removed in order to open the liquid crystal containing space 160c. However, if the amount of liquid crystal is dramatically excess, the four corners of the first spacer 142 are first removed to allow the liquid crystal containing space 160a to receive the dramatically excess volume of the liquid crystal. In addition, the spacer may be further removed to allow the liquid crystal containing spaces, 160a, 160b, 160c to be communicated.

In summary, the liquid crystal display panel of the present invention and the method for repairing the same have the following advantages:

1. The patterned spacer with the plurality of grooves is arranged in the non-display area in the liquid crystal display panel of the present invention. Since the patterned spacer is not located in the display area, the display quality cannot be affected.

2. When the liquid crystal non-uniformly distributed phenomenon happens to the liquid crystal display panel, the portion of spacers can be removed to allow the portion of the liquid crystal containing spaces to receive the excess of liquid crystal. As a result, an area of abnormal display on the liquid crystal display panel can be reduced or totally eliminated.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal display panel, comprising: a first substrate, comprising a non-display area; a second substrate, disposed on the first substrate; a liquid crystal layer, disposed between the first substrate and the second substrate; a patterned spacer, disposed between the non-display area of the first substrate and the second substrate, enclosing the liquid crystal layer and comprising a plurality of liquid crystal containing spaces; and a sealant, deposed between the non-display area of the first substrate and the second substrate, as well as enclosing the patterned spacer.

2. The liquid crystal display panel according to claim 1, wherein the patterned spacer comprises:
a first spacer, enclosing the liquid crystal layer;
a second spacer, enclosing the first spacer and spaced from the first spacer by a gap; and
a plurality of third spacers, disposed between the first spacer and the second spacer,
wherein the gap is further partitioned and the first spacer, the second spacer, the third spacer, the first substrate and the second substrate, define the liquid crystal containing spaces.

3. The liquid crystal display panel according to claim 1, wherein the first substrate and the second substrate are rectangular shapes.

4. The liquid crystal display panel according to claim 1, wherein material of the patterned spacer comprises a photo-resist material.

5. The liquid crystal display panel according to claim 1, further comprises a black matrix layer, disposed between the non-display area of the first substrate and the second substrate, as well as between the patterned spacer and the first substrate.

6. The liquid crystal display panel according to claim 1, wherein the first substrate comprises an active device array substrate.

7. The liquid crystal display panel according to claim 1, wherein the first substrate comprises a color filter substrate.

8. The liquid crystal display panel according to claim 1, wherein material of the sealant comprises heat-solidified glue.

9. The liquid crystal display panel according to claim 1, wherein material of the sealant comprises ultraviolet-solidified glue.

10. A method for repairing a liquid crystal display panel that has a liquid crystal non-uniformly distributed phenomenon, the method comprising:
partially removing the patterned spacers to open a portion of a plurality of liquid crystal containing spaces to receive an excess amount of the liquid crystal.

11. The method according to claim 10, wherein the method for partially removing the patterned spacers to opena portion of a plurality of liquid crystal containing spaces, implements a laser.

12. The method according to claim 11, wherein wavelengths of the laser are those of ultraviolet light.
